(19) United States
(12) Patent Application Publication
(10) Pub. No.: US 2017/0366985 A1
(43) Pub. Date: Dec. 21, 2017

(54) Measuring Neighboring Cells By User Equipment Served By Master Radio Access Node and Secondary Radio Access Node

(71) Applicant: Nokia Solutions and Networks Oy, Espoo (FI)

(72) Inventors: Tsunehiko CHIBA, Saitama (JP); Srinivasan SELVAGANAPATHY, Bangalore (IN)

(21) Appl. No.: 15/536,711

(22) PCT Filed: Dec. 9, 2015
(86) PCT No.: PCT/EP2015/079065

§ 371 Date: Jun. 16, 2017

(30) Foreign Application Priority Data
Dec. 17, 2014 (IN) 3747/DEL/2014

(51) Int. Cl. H04W 24/02; H04W 24/10

(52) U.S. Cl. CPC H04W 24/02; H04W 24/10

(57) ABSTRACT

There is provided updating neighboring cell information for a secondary radio access node controlled by a master radio access node. Neighboring cells are measured by user equipment served by the master radio access node and the secondary access node controlled by the master radio access node. Neighboring cell information is obtained. Neighboring cell information maintained in at least the secondary radio access node is updated on the basis of the obtained neighboring cell information.

### FIELD

The present invention relates to measuring neighboring cells by user equipment served by two radio access nodes.

### BACKGROUND

Automatic neighbor relation (ANR) is a function in evolved NodeB (eNB) according to 3^{rd} Generation Partnership Project (3GPP) Long Term Evolution (LTE) Release 12 Specifications. ANR relieves the network operator from the burden of manually managing Neighbor Relations (NRs). The ANR function searches for neighboring cells to the eNB based on measurements performed by User Equipment (UE) served by the eNB.

Dual Connectivity (DC) has been proposed as a feature for future releases of the 3GPP specifications for Evolved Universal Terrestrial Radio Access (E-UTRA) networks. Dual connectivity is a mode of operation of the UE. In the DC operation mode, the UE is configured with resources from two eNBs. One of the eNBs acts as a Master eNB (MeNB) and the other acts as a Secondary eNB (SeNB).

In the DC mode, the MeNB can configure the UE to perform measurements for ANR of the MeNB. Thus, the DC mode does not support ANR of the SeNB.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

Some embodiments provide improvements comprising updating neighboring cell information for a secondary radio access node controlled by a master radio access node.

### BRIEF DESCRIPTION OF THE DRAWINGS

In the following embodiments will be described in greater detail by means of preferred embodiments with reference to the accompanying drawings, in which

FIG. 1 presents an example of a mobile communications network according to an embodiment;

FIG. 2 illustrates an example of neighboring cell information maintained in an eNB, according to an embodiment;

FIG. 3 illustrates an example of a method according to an embodiment;

FIG. 4 illustrates an example of communications between entities of a mobile communications network according to an embodiment;

FIG. 5 illustrates a method for maintaining neighboring cell information in a master radio access node, according to an embodiment; and

FIG. 6 illustrates an example of an apparatus according to an embodiment.

### DETAILED DESCRIPTION

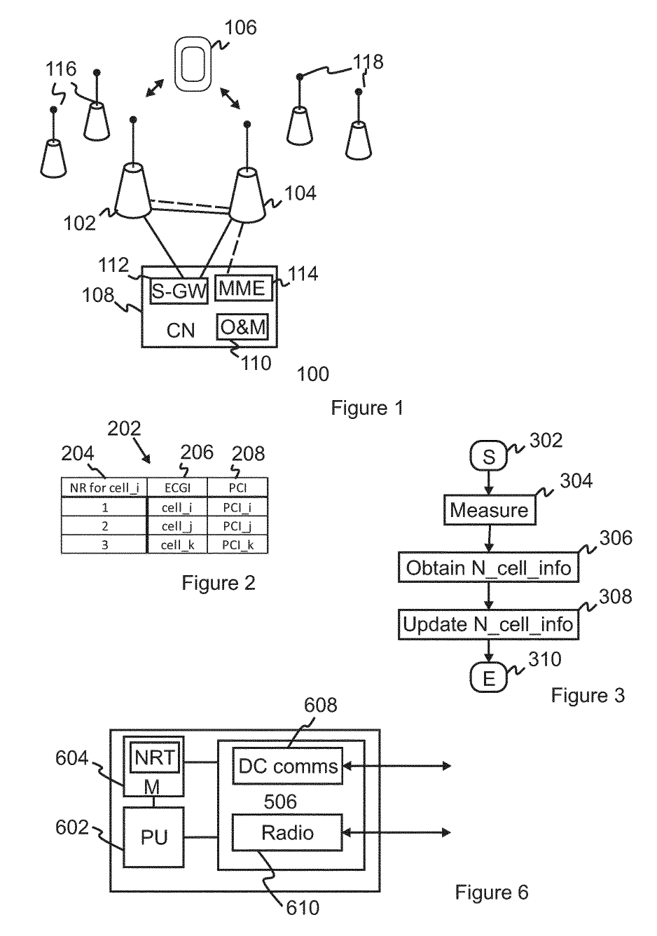

FIG. 1 presents an example of a mobile communications network 100 according to an embodiment. The mobile communications network may comprise a radio access network formed by radio access nodes 102, 104, 116, 118, e.g. eNBs, that provide wireless radio access to UE. The UE 106 is connected to eNBs 102, 104 over wireless radio channels. The UE may be in a DC operation mode. Accordingly, one of the eNBs may be a MeNB 104 and the other may be a SeNB 102. In the DC mode the UE may be allocated resources from both of the eNBs. Accordingly the UE may have resources allocated at the same time from both the MeNB and SeNB. The eNBs have coverage areas, where wireless communications between the UE and the eNBs is possible. The coverage areas may be defined by a range of the wireless radio communications.

Each eNB may have one or more cells that have resources for communications with the UE. The cells may have separate or overlapping or partly overlapping coverage areas. Each cell may be identified by a cell identifier for identifying the cell to the UE.

A resource may be a transmission unit of data over a wireless radio channel between the UE and an eNB. The transmission unit may be a unit for uplink transmission or downlink transmission of data. An uplink transmission refers to a direction of the transmission from the UE to the eNB, and the downlink transmission refers to a direction of the transmission from the eNB to the UE.

A Core Network (CN) 108 may be connected to the eNBs. The CN may comprise a control entity 114, a gateway entity 112 for routing user traffic and an Operation and Management system (O&M-system) 110. The control entity may act as a termination point in the CN for a control plane connection of the UE in the CN. The gateway entity may act as a termination point for a user plane connection of the UE in the CN. The O&M-system provides management of the entities of the communications network. The O&M-system may include a database storing a configuration of the network. The configuration of the network may include a frequency plan of the cells and identifiers of the cells. In E-UTRAN a cell may be identified by a Cell Global Identifier (ECGI) and/or by a Physical Cell Identifier (PCI). The ECGI is unique for a specific network but the PCI may be repeated inside the network.

A control plane connection of the UE to the CN may be provided in the radio access network by the MeNB that terminates the control plane connection of the UE. A user plane connection of the UE may be provided via the MeNB, via the SeNB or via both the MeNB and the SeNB. The MeNB and the SeNB may be connected for transfer of user data over the user plane connection and control data over a control plane connection. In FIG. 1, control plane connections are illustrated by dashed lines and user plane connections are illustrated by solid lines for the UE in a DC operation mode. Examples of the control entity in the CN may comprise a Mobility Management Entity (MME), Radio Network Controller (RNC) and a Switching Entity (SE). Examples of the gateway entity in the CN may comprise a Serving Gateway (SGW), a Gateway (GW), Serving GPRS Support Node (SGSN) and a Media Gateway (MGW).

The 3GPP Release 12 Specifications may be used to implement the mobile communications network illustrated in FIG. 1. For example, the connections between the CN and the eNBs may be implemented as S1 connections and the connections between the eNBs may be implemented as X2 connections. Although the present description uses the terminology of the 3GPP Release 12 Specifications, it should be appreciated that embodiments may be implemented in other mobile communications networks and entities.

In the context of 3GPP Release 12 specifications, a control plane connection of the UE may be implemented using Radio Resource Protocol (RRC) that is a layer 3 protocol. A user plane connection of the UE may be implemented using Packet Data Convergence Protocol (PDCP).

The MeNB and the SeNB may have neighboring eNBs 116, 118. The neighboring eNBs may have at least partly overlapping coverage areas with the coverage areas of the MeNB and the SeNB. The neighboring eNBs may have one or more cells similar to the MeNB and the SeNB. Accordingly, the overlapping coverage areas or partly overlapping coverage areas of the MeNB, SeNB and the neighboring eNBs may be coverage areas of the cells of the neighboring eNBs.

It should be appreciated that the UE may move with respect to and/or within the coverage areas of the MeNB, SeNB and the neighboring eNBs such that the SeNB may be changed to a new SeNB. On the other hand the movement of the UE may cause a handover of the UE from the MeNB to a new MeNB. Accordingly, neighboring cell information may be maintained at an eNB to facilitate change of MeNB and/or SeNB.

FIG. 2 illustrates an example of neighboring cell information maintained in an eNB. The neighboring cell information may be maintained in an eNB by an ANR function residing in the eNB. The ANR may manage a Neighbor Relation Table 202 (NRT). Neighboring cells to the eNB may be added as Neighbor Relations 204 (NRs) to the NRT. In the illustrated NRT 202, each row represents an NR to a specific cell. Each cell of the eNB may have neighboring information stored in the form of the NRT.

The ANR may find neighboring cells to the eNB or cells of the eNB by configuring UE to perform measurements. Measurements of the UE for ANR may include receiving broadcast messages from cells, when the UE is in the coverage area of the cell. The broadcast messages may include an identifier of the broadcasting cell. The measurement result may be sent from the UE to the eNB for updating the NRT.

An NR may include an identifier (cell_i, cell_j, cell_k) 206 of the neighboring cell. Preferably the identifier is unique in a specific mobile communications network. Accordingly, the identifier may be referred to as a global identifier in a specific mobile communications network. In E-UTRAN a cell may be identified by the E-UTRAN Cell Global Identifier (ECGI). The ECGI serves for identifying the cells above the physical layer. In the physical layer the cell may be identified by a Physical Cell Identifier (PCI_i, PCI_j, PCI_k) 208 (PCI). The PCI provides separation of transmissions from different cells in the physical layer.

FIG. 3 illustrates an example of a method according to an embodiment. The method may be performed by a MeNB or a SeNB, when UE is in a DC operation mode. Accordingly, the SeNB may operate under control of the MeNB. The SeNB may provide additional radio resources to the UE under control of the MeNB. The method may start 302, when the MENB and the SeNB are serving UE.

Neighboring cells may be measured 304 by the UE. The MeNB may cause measurements of the neighboring cells as a part of the ANR functionality. The ANR may configure the UE to perform measurements for neighboring cells as described with FIG. 2. The measurements may be performed at least on neighboring cells to the SeNB. Additionally also neighboring cells of the MeNB may be measured. The MeNB may cause the measurements by sending a request to the UE. The request may indicate the eNB, e.g. the SeNB and/or the MeNB, whose neighboring cells are to be measured. The indication may comprise a frequency to be measured. When the SeNB and MeNB use different frequencies, the frequency for the measurements may indicate whether neighboring cells to the MeNB or to the SeNB are measured. The request may further indicate the purpose of the measurements. The purpose may be for example to measure the strongest neighboring cell. The measurements may be performed as part of mobility measurements of the UE or as separate from mobility measurements. The mobility measurements may comprise measurements for preparing a handover of the UE for example.

Neighboring cell information of at least the SeNB may be obtained 306 as a result to the measurements. The neighboring cell information may be received from the UE and comprise results of the measurements performed by the UE. The results may comprise for example information identifying the strongest neighboring cell for the measured eNB. The information identifying the strongest neighboring cell may comprise an identifier of the cell, for example ECGI and/or PCI.

Neighboring cell information maintained in a SeNB may be updated 308 on the basis of the obtained 306 neighboring cell information. The obtained neighboring cell information may be used to update also the neighboring cell information maintained in the MeNB.

Neighboring cell information maintained in a SeNB may be updated by sending at least part of the obtained 306 neighboring cell information from the MeNB to the SeNB.

The method may end 310 after neighboring cell information maintained in the secondary access node has been updated.

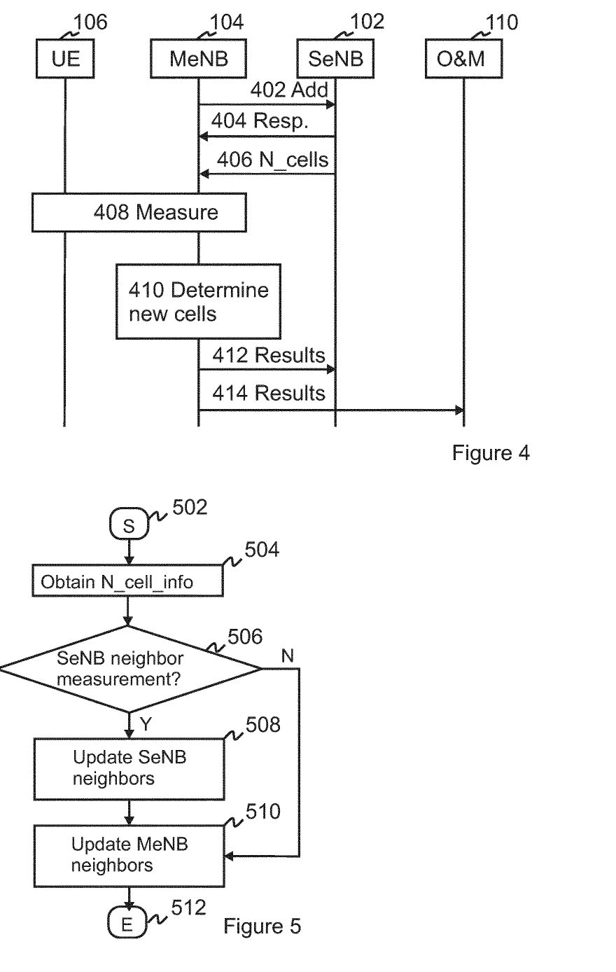

FIG. 4 illustrates an example of communications between entities of a mobile communications network according to an embodiment. The communications is described with reference to entities of the communications network in FIG. 1. A DC mode of the UE is established by a request 402 from the MeNB to the SeNB to add radio resources from one or more cells of the SeNB as additional resources to the UE. The SeNB may decide to admit or reject the request. If the request is admitted, the SeNB allocates the requested resources and the SeNB sends a response 404 to the MeNB indicating the radio resources allocated to the UE.

An example of establishing DC mode of the UE is described in Section 10.1.2. Dual Connectivity operation in “Change Request; 3GPP TSG-RAN WG2 Meeting #88, R2-144660; San Francisco, USA, 17-21 Nov. 2014”.

In an embodiment, a response to a request to establish a DC mode for the UE comprises neighboring cell information 406 of the SeNB. In this way the MeNB may obtain information for updating the SeNB regarding new neighboring cells to the SeNB.

In an embodiment a response 404 to a request to establish a DC operation mode for the UE comprises a request to perform measurements of neighboring cells neighboring cells of the SeNB.

The MeNB may request the UE to measure 408 neighboring cells. The measurements may be performed as described in step 304 in FIG. 3. Following the request for the measurements, the MeNB may obtain neighboring cell information as described in step 306 of FIG. 3.

In an embodiment, the MeNB may perform neighboring cell measurements in response to a request 404 from the SeNB to measure neighboring cells of the SeNB.

Referring to FIG. 4, in an embodiment the MeNB may determine 410 new cells to the neighboring cell information obtained 406 from the SeNB. The determining may comprise comparing the neighboring cell information obtained as measurement results from the UE to the neighboring cell information obtained from the SeNB.

Neighboring cell information obtained by measurements 408 may be sent 412 to the SeNB for updating the neighboring cell information maintained in the SeNB. In this way the neighboring cell information may be obtained at the SeNB from the MENB, in the DC operation mode of the UE.

In an embodiment neighboring cell information obtained by measurements 408 may be communicated to the SeNB as part of a release procedure of the SeNB. The SeNB may be released, when the SeNB in the DC mode is changed to a new SeNB. A decision to perform change the SeNB may trigger sending the neighboring cell information. In this way the neighboring cell information maintained in the SeNB may be updated before the SeNB is changed to the new SeNB.

In an embodiment neighboring cell information obtained by measurements 408 may identify at least one neighboring cell of the SeNB. In this way the MeNB may obtain information for updating the neighboring cell information maintained in the SeNB.

In an embodiment, neighboring cell information sent 412 to the SeNB may comprise neighboring cell information indicating new cells to the neighboring cell information maintained in the SeNB.

In an embodiment, neighboring cell information may be sent 412 from the MeNB to the SeNB as as an additional parameter in a user-plane data packet header. In one example, the neighboring cell information may be communicated as a GPRS Tunneling Protocol (GTP) extension in a GTP packet carrying a PDCP protocol data unit.

In an embodiment, neighboring cell information may be informed 414 to an O&M-system. The MeNB may send the neighboring cell information obtained by the measurements 408 or new cells determined 410 to the SeNB, to the O&M-system.

FIG. 5 illustrates a method for maintaining neighboring cell information in a MeNB, according to an embodiment. The method may start 502 when a DC operation mode has been established for the UE. The results of neighboring cell measurements may be obtained 504 from the UE as described in step 306 in FIG. 3, for example.

If 506 the measurement results include results for measurements performed for neighboring cells of the SeNB, the neighboring cell information of the SeNB may be updated 508. The updating may be performed as described in step 412 of FIG. 4. After the neighboring cell information of the SeNB has been updated the measurement results may be used to update 510 the MeNB neighboring cell information. It should be appreciated that in the DC operation mode of the UE the measurement results may be considered by default to include results for measurements performed on neighboring cells of the SeNB. On the other hand the measurement results may be determined to include results for measurement results for neighboring cells of a specific eNB, i.e. the SeNB or MeNB, on the basis of measurement frequency used for the measurements as described in 306. The information of the measurement target, e.g. neighboring cells of the MeNB or the SeNB, may be stored in the MeNB and used to select 506 how to use the measurement results to update neighboring cell information.

In an embodiment in a DC mode of the UE neighboring cell information maintained in a SeNB may be updated before updating neighboring cell information maintained in the MeNB. Accordingly, neighboring cell information obtained by measurements may be referred against neighboring cell information, e.g. an SeNB NRT, maintained for a SeNB and/or Cell of the SenB before the neighboring cell information obtained by measurements are referred against neigboring cell information, e.g. an MeNB NRT, maintained in the MeNB for finding the additional info for reported cell. Since the measurement results for SeNB neighbors are first checked against SeNB neighboring cell information, cells known to the SeNB may be detected and false detection of new neighboring cells may be avoided. This is particularly useful, when the measurement results identify the cells by an identifier, for example the PCI, that may be used by more than one cell in a specific network. Two cells having the same identifier, such as the PCI, may be particularly likely, when the MeNB is a macro cell eNB and SeNBs are nano cell or pico cell eNBs, whereby a number of nano cells and pico cells under the MeNB may be large. There may be a plurality of SeNBs under coverage area or with an overlapping coverage area, or nearby a single MeNB.

In an embodiment, after the neighboring cell information of the SeNB is updated 508 and all the obtained 504 measurement results were used to update the neighboring cell information of the SeNB, the process may end 512 without updating 510 the MeNB neighboring cell information.

If 506 the measurement results include results for measurements on neighboring cells of the MeNB, the neighboring cell information of the SeNB may be updated. This may be a default operation, when the UE is not in the DC operation mode and there are no SeNBs to the MeNB.

The method may end 512 after the measurement results of the SeNB and/or MeNB have been updated.

FIG. 6 illustrates an example of an apparatus according to an embodiment. The apparatus comprises at least one Processing Unit (PU), at least one memory 604 and an interfacing unit 606. The Memory (M) may store instructions to be executed by the processor. The PU, interfacing unit and the M may be electrically connected to cause execution of a method according to an embodiment. The interfacing unit may provide communications of data and/or messages to and from the apparatus such that neighbor cell information may be communicated between eNBs.

In an embodiment, the apparatus may be a radio access node such s a master radio access node or a secondary radio access node. The radio access node may be an eNB.

In an embodiment, the interfacing unit 606 may comprise a unit 610 for wireless radio communications to and/from UE. In this way the apparatus may communicate data and/or messages to and/from the UE.

In an embodiment, the interfacing unit may comprise a unit 608 for communicating neighboring cell information and/or a request for neighboring cell information between MeNB and SeNB. In this way neighboring cell information may be updated for SeNB controlled by MeNB in DC operation mode of the UE.

An embodiment concerns a computer program embodied on a computer-readable storage medium, the computer program comprising program to execute a process comprising a method according an embodiment.

An embodiment concerns a communication system, for example a mobile communications system illustrated in FIG. 1. The communications system comprises a MeNB node and a SeNB configurable to serve the same user equipment, wherein the MeNB and the SeNB are connected to cause execution of a method according an embodiment. The configuration of the MeNB and the SeNB to serve the UE may be provided by establishing a DC operation mode for the UE as described above. In the DC operation mode the UE may be allocated radio resources from both the MeNB and SeNB at the same time. An X2 connection between the MENB and the SeNB may provide communications of the neighboring cell information, updates to the neighboring cell information and/or requests for the neighboring cell information.

The techniques described herein may be implemented by various means so that an apparatus implementing one or more functions of a radio access node, a master radio access node, a secondary radio access node, a MeNB or SeNB described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

Thus, according to an embodiment, the apparatus such as of a radio access node, a master radio access node, a secondary radio access node, a MeNB or SeNB may comprise processing means configured to carry out any of the embodiments of FIGS. 3, 4 and 5.

In an embodiment, the at least one processor 602 the memory 604 and a computer program code form an embodiment of processing means for carrying out an embodiment. According to an embodiment there is provided a computer program embodied on a computer-readable storage medium, the computer program comprising program to execute an embodiment.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

In an embodiment there is provided a computer program product for a computer, comprising software code portions for performing one or more functions or steps of an embodiment.

It will be obvious to a person skilled in the art that, as the technology advances, the inventive concept can be implemented in various ways. The invention and its embodiments are not limited to the examples described above but may vary within the scope of the claims.

1. A method comprising:
measuring neighboring cells by user equipment served by a master radio access node and a secondary radio access node controlled by the master radio access node;
obtaining neighboring cell information of the secondary radio access node as a result to the measurements;
updating neighboring cell information maintained in at least the secondary radio access node on the basis of the obtained neighboring cell information.

2. A method according to claim 1, comprising:
obtaining neighboring cell information maintained in the secondary radio access node;
determining new cells to the neighboring cell information obtained from the secondary radio access node; sending information indicating the new cells to the secondary radio access node.

3. A method according to claim 1, comprising:
updating neighboring cell information maintained in at least the secondary radio access node before updating neighboring cell information maintained in the master radio access node.

4. A method according to claim 1, wherein the master radio access node is caused to perform measurements of neighboring cells in response to a request from a secondary radio access node to measure neighboring cells of the secondary radio access node.

5. A method according to claim 4, wherein the request is obtained as a part of addition procedure of a secondary radio access node under control of the master scheduler.

6. A method according to claim 1, wherein the neighboring cell information is communicated to the secondary radio access node as part of a release procedure of the secondary radio access node.

7. A method according to claim 1, wherein the neighboring cell information is obtained at the secondary radio access node from the master radio access node.

8. A method according to claim 1, wherein the neighboring cell information of the secondary radio access node is informed to an operation and management system.

9. A method according to claim 1, wherein obtained neighboring cell information identifies at least one neighboring cell of the secondary radio access node.

10. A method according to claim 1, wherein the neighboring cell information is communicated to the secondary radio access node as an additional parameter in a user-plane data packet header.

11. An apparatus, comprising:
at least one processor, and
at least one memory for storing instructions to be executed by the processor, wherein
the at least one memory and the instructions are configured to, with the at least one processor, cause the apparatus at least to perform a method according to claim 1.

12. An apparatus according to claim 11, wherein the apparatus is a master radio access node or a secondary access node.

13. An apparatus according to claim 11, comprising an interfacing unit for communicating the neighboring cell information and/or a request for neighboring cell information between the master radio access node and the secondary access node.

14. A computer program product for a computer, comprising software code portions for performing the steps of claim 1 when said product is run on a computer.

15. A computer program embodied on a computer-readable storage medium, the computer program comprising program to execute a process comprising a method according to claim 1.

16. A communication system comprising a master radio access node and a secondary access node configurable to serve the same user equipment, wherein the master radio access node and the secondary access node are interconnected to cause execution of a method according to claim 1.
